(19) United States
(12) Patent Application Publication
(10) Pub. No.: US 2020/0137001 A1
(43) Pub. Date: Apr. 30, 2020

(54) GENERATING RESPONSES IN AUTOMATED CHATTING

(71) Applicant: MICROSOFT TECHNOLOGY LICENSING, LLC, Redmond, WA (US)

(72) Inventors: Xianchao WU, Redmond, WA (US); Zhan CHEN, Redmond, WA (US); Wei WU, Redmond, WA (US)

(73) Assignee: MICROSOFT TECHNOLOGY LICENSING, LLC, Redmond, WA (US)

(21) Appl. No.: 16/626,430

(22) PCT Filed: Jun. 29, 2017
(86) PCT No.: PCT/CN2017/090821

§ 371 Date: Dec. 24, 2019

(51) Int. Cl. H04L 12/58; G06F 40/253; G06F 40/35; G06F 40/56

(52) U.S. Cl. CPC H04L 51/02; G06F 40/56; G06F 40/35; G06F 40/253

(57) ABSTRACT

The present disclosure provides method and apparatus for generating responses in automated chatting. A message may be received in a session. Personality comparison between a first character and a user may be performed. A response may be generated based at least on the personality comparison, the response being in a language style of a second character.

### BACKGROUND

Artificial Intelligence (AI) chatbot is becoming more and more popular, and is being applied in an increasing number of scenarios. The chatbot is designed to simulate people's conversation, and may chat with users by text, speech, image, etc. Generally, the chatbot may scan for keywords within a message input by a user or apply natural language processing on the message, and provide a response with the most matching keywords or the most similar wording pattern to the user.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose method and apparatus for generating responses in automated chatting. A message may be received in a session. Personality comparison between a first character and a user may be performed. A response may be generated based at least on the personality comparison, the response being in a language style of a second character.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary network architecture deploying a chatbot according to an embodiment.

FIG. 2 illustrates an exemplary application scenario of a chatbot according to an embodiment.

FIG. 3 illustrates an exemplary chatbot system according to an embodiment.

FIG. 4 illustrates an exemplary user interface according to an embodiment.

FIG. 5 illustrates an exemplary chat window according to an embodiment.

FIG. 6 illustrates an exemplary chat window according to an embodiment.

FIG. 7 illustrates an exemplary chat window for performing an implicit personality test according to an embodiment.

FIG. 8 illustrates an exemplary result of an implicit personality test according to an embodiment.

FIG. 9 illustrates an exemplary process for performing an implicit personality test according to an embodiment.

FIG. 10 illustrates an exemplary process for obtaining a training dataset for a personality classification model according to an embodiment.

FIG. 11 illustrates an exemplary personality classification model according to an embodiment.

FIG. 12 illustrates an exemplary process for determining character similarity according to an embodiment.

FIG. 13 illustrates an exemplary process for applying a response ranking model to determine a response according to an embodiment.

FIG. 14 illustrates an exemplary process for establishing a language model for a target character according to an embodiment.

FIG. 15 illustrates an exemplary language style rewriting model according to an embodiment.

FIG. 16 illustrates an exemplary framework for generating responses through Dynamic Memory Network (DMN) according to an embodiment.

FIG. 17 illustrates a flowchart of an exemplary method for generating responses in automated chatting according to an embodiment.

FIG. 18 illustrates an exemplary apparatus for generating responses in automated chatting according to an embodiment.

FIG. 19 illustrates an exemplary apparatus for generating responses in automated chatting according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Thousands of characters were designed by human in cartoons, movies or plays. These characters may be artificially-created fantasy, virtual or fictional characters that exist in scenarios and environments built or depicted in the cartoons, movies or plays. These characters may comprise animation characters, characters played by humans, etc. Some characters may be very famous and popular. For example, the famous character “Doraemon” that exists in a Japanese cartoon named “Doraemon” has his typical pre-defined characteristics, and is liked by millions of people from children to aged persons.

It will be exciting if people in the real-world can interact with characters in cartoons, movies or plays through conversation. For example, some people may wish to freely communicate with Doraemon, just like other characters, e.g., the boy named Nobita, the girl named Shizuka, in the cartoon “Doraemon”.

Embodiments of the present disclosure propose to transfer characteristics from a target character into a chatbot, such that the chatbot may act as the target character to freely chat with people in the real-world.

Conventionally, a chatbot may conduct automated sessions with a user. Herein, “session” may refer to a time-continuous dialog between two chatting participants and may include messages and responses in the dialog, wherein “message” refers to any information input by the user, e.g., queries from the user, answers of the user to questions from the chatbot, opinions of the user, etc., and “response” refers to any information provided by the chatbot, e.g., answers of the chatbot to questions from the user, comments of the chatbot, etc.

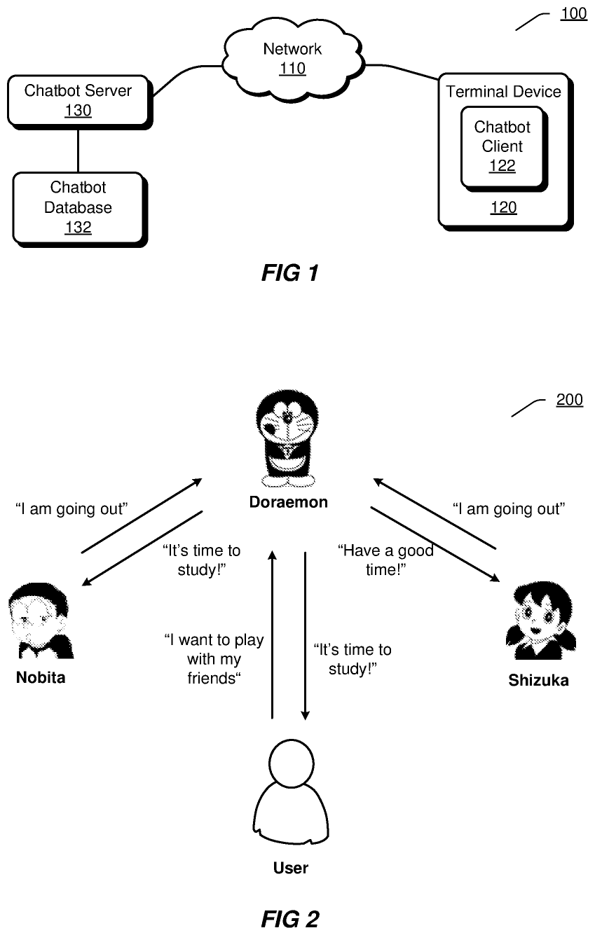

FIG. 1 illustrates an exemplary network architecture 100 deploying a chatbot according to an embodiment.

In FIG. 1, a network 110 is applied for interconnecting among a terminal device 120 and a chatbot server 130.

The network 110 may be any type of networks capable of interconnecting network entities. The network 110 may be a single network or a combination of various networks. In terms of coverage range, the network 110 may be a Local Area Network (LAN), a Wide Area Network (WAN), etc. In terms of carrying medium, the network 110 may be a wireline network, a wireless network, etc. In terms of data switching techniques, the network 110 may be a circuit switching network, a packet switching network, etc.

The terminal device 120 may be any type of electronic computing devices capable of connecting to the network 110, assessing servers or websites on the network 110, processing data or signals, etc. For example, the terminal device 120 may be desktop computers, laptops, tablets, smart phones, etc. Although only one terminal device is shown in FIG. 1, it should be appreciated that a different number of terminal devices may connect to the network 110.

In an implementation, the terminal device 120 may be used by a user. The terminal device 120 may include a chatbot client 122 which may provide automated chatting service for the user. In some cases, the chatbot client 122 may interact with the chatbot server 130. For example, the chatbot client 122 may transmit messages input by the user to the chatbot server 130, and receive responses associated with the messages from the chatbot server 130. However, it should be appreciated that, in other cases, instead of interacting with the chatbot server 130, the chatbot client 122 may also locally generate responses to messages input by the user.

The chatbot server 130 may connect to or incorporate a chatbot database 132. The chatbot database 132 may comprise information that can be used by the chatbot server 130 for generating responses.

It should be appreciated that all the network entities shown in FIG. 1 are exemplary, and depending on specific application requirements, any other network entities may be involved in the application scenario 100.

According to the embodiments of the present disclosure, in order to enable the chatbot, that acts as the target character, to provide responses to messages from people in the real-world in a feasible and intellectual way, besides capturing and modeling characteristics of the target character, it is also important to determine a reference character corresponding to a user who is talking with the chatbot, such that the chatbot may respond to messages from the user in a manner like the target character talks with the reference character in the cartoon, movie or play.

FIG. 2 illustrates an exemplary application scenario 200 of a chatbot according to an embodiment.

As shown in FIG. 2, “Doraemon”, “Nobita” and “Shizuka” are characters in the cartoon named “Doraemon”. According to personality settings for “Nobita” and “Shizuka” in the cartoon, Nobita is a little bit lazy boy and not much interested in study, but Shizuka is a girl who is nice to others and good at study. There is a big difference of conversations between Doraemon and Nobita and between Doraemon and Shizuka. Since Nobita is lazy and does not like study, when Nobita says “I am going out” to Doraemon, Doraemon may be serious and says “It's time to study!”. While since Shizuka is good at study, when Shizuka says “I am going out” to Doraemon, Doraemon may be kind and says “Have a good time!”. It shows that Doraemon may talk with different characters in difference manners.

After transferring characteristics of Doraemon to a chatbot, the chatbot may evaluate personality of a user who is talking with the chatbot and determine which reference character is the user like in terms of personality. Thus, the chatbot that acts as Doraemon may respond to the user in a manner similar as talking to the reference character. For example, assuming that the user is determined as having a personality similar with Nobita, then when the user says “I want to play with my friends” to the chatbot, the chatbot may respond by “It's time to study!” just like the chatbot is talking to Nobita.

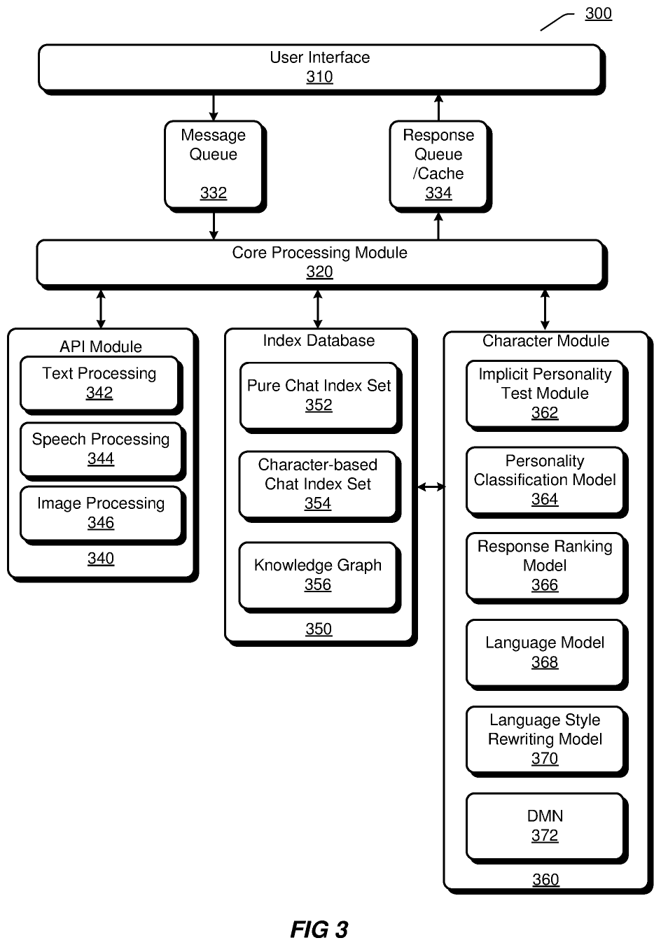

FIG. 3 illustrates an exemplary chatbot system 300 according to an embodiment.

The chatbot system 300 may comprise a user interface (UI) 310 for presenting a chat window. The chat window may be used by the chatbot for interacting with a user.

The chatbot system 300 may comprise a core processing module 320. The core processing module 320 is configured for, during operation of the chatbot, providing processing capabilities through cooperation with other modules of the chatbot system 300.

The core processing module 320 may obtain messages input by the user in the chat window, and store the messages in the message queue 332. The messages may be in various multimedia forms, such as, text, speech, image, video, etc.

The core processing module 320 may process the messages in the message queue 332 in a first-in-first-out manner. The core processing module 320 may invoke processing units in an application program interface (API) module 340 for processing various forms of messages. The API module 340 may comprise a text processing unit 342, a speech processing unit 344, an image processing unit 346, etc.

For a text message, the text processing unit 342 may perform text understanding on the text message, and the core processing module 320 may further determine a text response.

For a speech message, the speech processing unit 344 may perform a speech-to-text conversion on the speech message to obtain text sentences, the text processing unit 342 may perform text understanding on the obtained text sentences, and the core processing module 320 may further determine a text response. If it is determined to provide a response in speech, the speech processing unit 344 may perform a text-to-speech conversion on the text response to generate a corresponding speech response.

For an image message, the image processing unit 346 may perform image recognition on the image message to generate corresponding texts, and the core processing module 320 may further determine a text response. In some cases, the image processing unit 346 may also be used for obtaining an image response based on the text response.

Moreover, although not shown in FIG. 3, the API module 340 may also comprise any other processing units. For example, the API module 340 may comprise a video processing unit for cooperating with the core processing module 320 to process a video message and determine a response.

The core processing module 320 may determine responses through an index database 350. The index database 350 may comprise a plurality of index items that can be retrieved by the core processing module 320 as responses. The index items in the index database 350 may be classified into a pure chat index set 352, a character-based chat index set 354 and a knowledge graph 356. The pure chat index set 352 may comprise index items that are prepared for free chatting between the chatbot and users, and may be established with data from, e.g., social networks. The index items in the pure chat index set 352 may or may not be in a form of question-answer (QA) pair, e.g., <question, answer>. Question-answer pair may also be referred to as message-response pair. The character-based chat index set 354 may comprise index items that are established from character's lines in cartoons, movies or plays. Herein, “lines” may refer to words or sentences said by characters in the cartoons, movies or plays. The index items in the character-based chat index set 354 may be in a form of <question, answer, character 1, character 2>, where the “question” is said by the “character 1” and the “answer” is said by the “character 2”. Thus, the character-based chat index set 354 may at least comprise conversation information between any two characters in the cartoons, movies or plays. The knowledge graph 356 may comprise various background information of a target character, e.g., age, experiences, preferences, etc. of the target character. The knowledge graph 356 may be established from plain texts or character's lines in the cartoons, movies or plays where the target character exists. In some implementations, QA pairs may be further generated from the background information of the target character and included in the knowledge graph 356.

The chatbot system 300 may comprise a character module 360 which is a collection of functions that enable the chatbot to behave like the target character, e.g., providing responses in a language style of the target character, etc. The character module 360 may access the index database 350.

The character module 360 may comprise an implicit personality test module 362. The implicit personality test module 362 may perform personality questionnaire on a user in an implicit way. For examples, questions of a personality test may be appended to a session between the chatbot and the user, and answers from the user may be collected in the session. The implicit personality test module 362 may perform sentiment analysis on the answers to determine corresponding emotion categories, e.g., tendencies reflected by the answers, and accordingly determine personality scores of the user. The personality scores may be further used for performing personality comparisons between the user and one or more reference characters to obtain a character similarity result, thus determining a reference character that corresponds to the user in personality. The “personality scores” may be given based on big-five personality traits. The big-five personality traits follow a five-factor model (FFM) which is based on common language descriptors of personality. The FFM is widely used for describing human personality or psyche by five personality factors. The five personality factors may comprise:
Openness to experience: For example, “The travel related topic is interesting and I would like to learn more about it” is a positive expression for supporting “openness to experience”, and “I would like to continue my former experience, instead of challenging a new domain” shows a negative attitude to “openness to experience”;
Conscientiousness: For example, “I will try my best until the problem is solved” is a positive expression of “conscientiousness”, and “It's not my business now. Please ask someone else to help you” is a rather negative evidence of “conscientiousness”;
Extraversion: For example, “Shall we attend Mary's family party tonight? I prepared a bottle of red wine” is a positive sentence for “extraversion”, and “No, I would rather stay at home. I do not want to see so many new faces” is a negative emotion for “extraversion”;
Agreeableness: For example, “I'm glad to give a hand anytime necessary” and

“Stay away from me and shut up” are positive and negative examples for “agreeableness” respectively;
Neuroticism: For example, “When I feel sad, I was easy to be angry and hurt my friends or my family members” and “I would like to do some exercises and try to relax when I am feeling sad” are two examples for different directions of “neuroticism”.

The character module 360 may comprise a personality classification model 364. The personality classification model 364 may be established for generating personality scores from one or more input sentences. For example, the personality classification model 364 may output personality scores based on a session log of the user or lines of a reference character. The personality classification model 364 may be based on, such as, a recurrent convolutional neural network (RCNN). When applying the personality classification model 364, it may output a personality score for each of the five personality factors as mentioned above. This set of personality scores may be further used for performing personality comparisons between the user and one or more reference characters to obtain a character similarity result, thus determining a reference character that corresponds to the user in personality.

The character module 360 may comprise a response ranking model 366. The response ranking model 366 may be used for determining one or more responses to a current message from the user based on at least one of the pure chat index set 352, the character-based chat index set 354 and the knowledge graph 356. During determining the one or more responses, the response ranking model 366 may make a reference to the character similarity result as mentioned above. In an implementation, a top-ranked response determined by the response ranking model 366 may be provided to the user directly as a reply to the current message from the user.

The character module 360 may comprise a language model 368. The language model 368 may be established for modeling the language style of the target character.

The character module 360 may comprise a language style rewriting model 370. The language style rewriting model 370 may rewrite a sentence into another sentence that is in the language style of the target character. In some implementations, the language style rewriting model 370 may perform the rewriting operation with the language model 368 and/or the personality classification model 364 cooperatively.

The character module 360 may comprise a dynamic memory network (DMN) module 372 for reasoning out a response to a current message from the user. In an implementation, the DMN module 372 may cooperate with the response ranking model 366, and in this case, the response ranking model 366 may provide one or more candidate responses as inputs to the DMN module 372. In an implementation, the DMN module 372 may cooperate with the language style rewriting model 370 such that the response reasoned out by the DMN module 372 may be in the language style of the target character.

The core processing module 320 may provide determined responses to a response queue or response cache 334. For example, the response cache 334 may ensure that a sequence of responses can be displayed in a pre-defined time stream. Assuming that, for a message, there are no less than two responses determined by the core processing module 320, then a time-delay setting for the responses may be necessary. For example, if a message input by the user is “Did you eat your breakfast?”, two responses may be determined, such as, a first response “Yes, I ate bread” and a second response “How about you? Still feeling hungry?”. In this case, through the response cache 334, the chatbot may ensure that the first response is provided to the user immediately. Further, the chatbot may ensure that the second response is provided in a time delay, such as 1 or 2 seconds, so that the second response will be provided to the user 1 or 2 seconds after the first response. As such, the response cache 334 may manage the to-be-sent responses and appropriate timing for each response.

The responses in the response queue or response cache 334 may be further transferred to the UI 310 such that the responses can be displayed to the user in the chat window.

It should be appreciated that all the elements shown in the chatbot system 300 in FIG. 3 are exemplary, and depending on specific application requirements, any shown elements may be omitted and any other elements may be involved in the chatbot system 300.

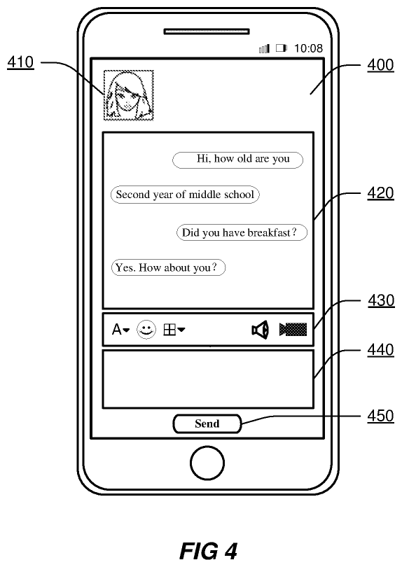

FIG. 4 illustrates an exemplary user interface 400 according to an embodiment.

The user interface 400 is included in a terminal device, and may comprise a chatbot icon 410, a presentation area 420, a control area 430 and an input area 440. The chatbot icon 410 may be a photo or picture representing the chatbot. The presentation area 420 displays a chat window that contains messages and responses in a session between a user and the chatbot. The control area 430 includes a plurality of virtual buttons for the user to perform message input settings. For example, the user may select to make a voice input, attach image files, select emoji symbols, make a short-cut of the current screen, etc. through the control area 430. The input area 440 is used by the user for inputting messages. For example, the user may type text through the input area 440. The user interface 400 may further comprise a virtual button 450 for confirming to send input messages. If the user touches the virtual button 450, the messages input in the input area 440 may be sent to the presentation area 420.

It should be appreciated that all the elements and their layout shown in FIG. 4 are exemplary. Depending on specific application requirements, the user interface in FIG. 4 may omit or add any elements, and the layout of the elements in the user interface in FIG. 4 may also be changed in various approaches.

According to some embodiments of the present disclosure, target character-based chatting may be introduced by a free chatting-oriented chatbot. For example, during a session between the chatbot and a user, the chatbot may inquire the user whether a target character-based chatting is desired or the chatbot may receive a request of having a target character-based chatting from the user. Upon the user selects or designates a target character, the chatbot may act as the target character to chat with the user. In this case, the embodiments of the present disclosure may be implemented in any general terminal devices that running a chatbot application.

FIG. 5 illustrates an exemplary chat window 500 according to an embodiment. The chat window 500 shows a procedure of introducing target character-based chatting by a free chatting-oriented chatbot.

A user may input a message “Show me available characters” to indicate that the user wants to talk with a target character. A chatbot named “Rinna” may respond by a list of candidate target characters for selection by the user. For example, the list of candidate target characters may comprise “1. Doraemon”, “2. Mickey mouse” and “3. Kung-Fu panda”. When the user selects “1”, i.e., “Doraemon”, the chatbot may change its icon to a photo of the target character “Doraemon” and start to chat with the user as Doraemon. When the user inputs a message “Back to Rinna” to indicate that the user wants to stop the chatting with Doraemon and return to chat with the chatbot “Rinna”, Rinna will come back in the chat window 500 and chat with the user again.

The session in the chat window 500 is exemplary. It should be appreciated that the user may select any one of the candidate target characters, and the chatbot may act as the selected target character to chat with the user. That is, the user is allowed to freely change the target character. This design may provide the user with variance and diversity of target characters. For example, through buying a single terminal device running the chatbot or installing a single chatbot application, the user may chat with various target characters. Through updating character modules of the chatbot, it is easy to update one or more target characters having been supported by the chatbot or append new target characters to be supported by the chatbot.

According to some embodiments of the present disclosure, it is not necessary to introduce target character-based chatting by a free chatting-oriented chatbot. Instead, a user may directly chat with a target character acted by a chatbot, without the need of selecting the target character. In this case, besides general terminal devices, the chatbot acting as the target character may also be implemented in a specially-designed device. Appearance or outline of the specially-designed device may be like the target character. For example, if the target character is Doraemon, the specially-designed device may be an electrical toy with the Doraemon's appearance. The specially-designed device may comprise a software platform that implements the chatbot acting as the target character. The specially-designed device may further comprise a hardware platform which includes various hardware components, such as, screen, processing units, power management units, WiFi module, loudspeaker, etc.

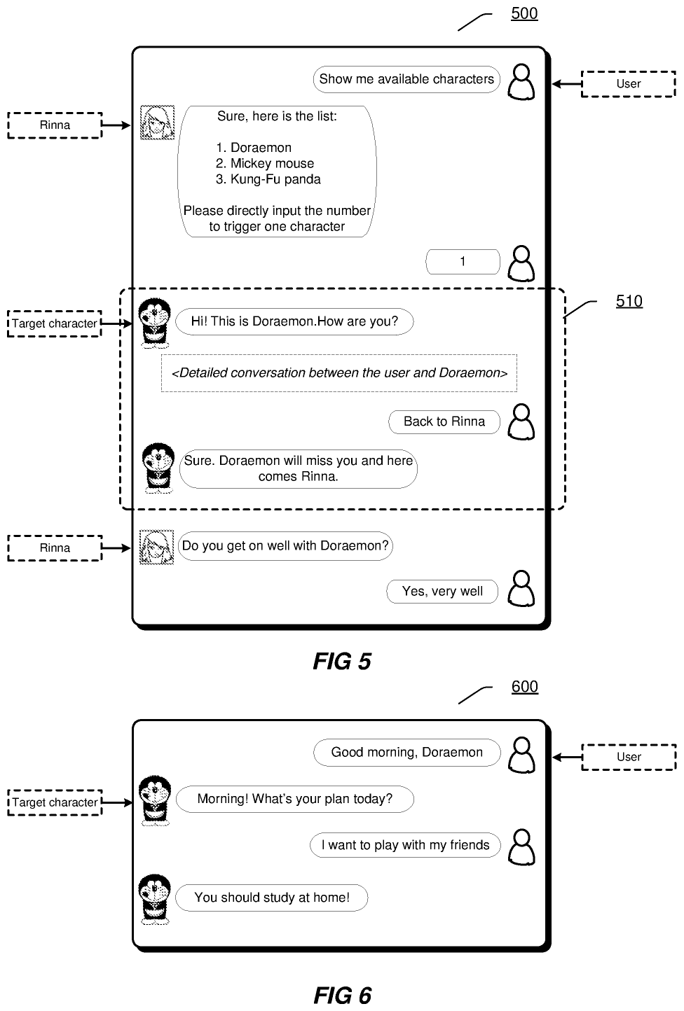

FIG. 6 illustrates an exemplary chat window 600 according to an embodiment. The chat window 600 shows direct chatting between a user and a chatbot acting as a target character.

The user is already known that he is chatting with a target character, e.g., “Doraemon”, and thus the user may input a message “Good morning, Doraemon” to say hello to Doraemon. Then, the chatbot may chat with the user as Doraemon directly.

Through direct chatting between the user and the target character as mentioned above, interactions between the user and the chatbot may be simplified since the operation of selecting the target character is omitted. Furthermore, the target character-like appearance of the terminal device may also be attractive for users.

It should be appreciated that although two exemplary chat windows are discussed above in connection with FIG. 5 and FIG. 6, the embodiments of the present disclosure are not limited to be implemented in a visible way, e.g., texts. In some implementations, the user may communicate with the chatbot by voices. For example, the user may select a target character by voices, the user may have a voice chatting with the target character acted by the chatbot, etc.

According to the embodiments of the present disclosure, implicit personality tests may be performed on a user so as to determine characteristics of the user in personality.

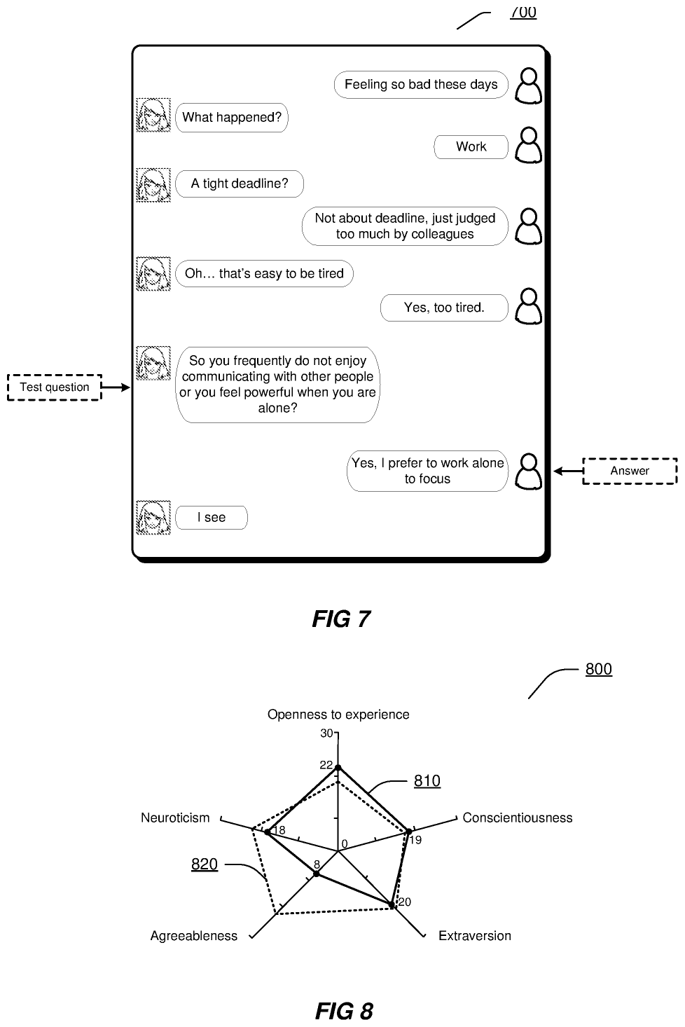

FIG. 7 illustrates an exemplary chat window 700 for performing an implicit personality test according to an embodiment.

The implicit personality test may refer to performing a personality test in an implicit way, such as, sending test questions and collecting a user's answers in a session in a way that is not recognizable for the user. Test questions and reference answers of the implicit personality test may be extracted from any existing manually-designed personality tests previously. When deciding to provide a test question to the user, the chatbot may determine the test question based at least on a current session between the user and the chatbot. An implicit personality test would not take too much time of the user, and may avoid that the user answers in an imaginary or fake way when the user is told to take a personality test.

As shown in the chat window 700, during the current session between the user and the chatbot, the user says that he is feeling sad because of work and he is too tired because of being judged too much by colleagues.

Based on the current session, the chatbot may decide to start an implicit personality test, and may determine at least one test question that is associated with the current session, e.g., “So you frequently do not enjoy communicating with other people or you feel powerful when you are alone?”. This test question directs to obtaining the user's tendency in a personality factor “extraversion”.

An answer “Yes, I prefer to work alone to focus” may be received from the user. From the answer, the chatbot may acknowledge that the user does not enjoy communicating with other people and likes working alone, and thus may determine that the user's personality is negative in the personality factor “extraversion”.

It should be appreciated that the implicit personality test in the chat window 700 is exemplary, and the embodiments of the present disclosure are not limited to any detailed expressions or procedures in the chat window 700.

Moreover, although not shown in FIG. 7, it should be appreciated that a result of the implicit personality test may be generated by the chatbot and shown to the user. In an implementation, the result of the implicit personality test may comprise a set of personality scores that are based on big-five personality traits. Each of the five personality factors may have a corresponding personality score. A personality score may be ranged in [−1, 1], or be projected to any other metrics, e.g., [0, 30].

FIG. 8 illustrates an exemplary result 800 of an implicit personality test according to an embodiment. The result 800 may be obtained from an implicit personality test on a user, and may be presented in, such as, the chat window 700, or in any other independent windows shown in a terminal device.

As shown in FIG. 8, the result 800 may comprise five dimensions, representing the five personality factors “Openness to experience”, “Conscientiousness”, “Extraversion”, “Agreeableness”, and “Neuroticism” respectively.

Personality of the user is shown by a pentagon 810. The pentagon 810 is formed by connection lines among five points on the five dimensions, each point corresponding to a personality score in a relevant personality factor. The personality scores are ranged in [0, 30] in FIG. 8. For example, a personality score in the personality factor “Openness to experience” obtained by the user is “22”, a personality score in the personality factor “Conscientiousness” obtained by the user is “19”, a personality score in the personality factor “Extraversion” obtained by the user is “20”, a personality score in the personality factor “Agreeableness” obtained by the user is “8”, and a personality score in the personality factor “Neuroticism” obtained by the user is “18”.

Another dashed pentagon 820 may be optionally shown in the result 800. The dashed pentagon 820 may be formed by average personality scores of other users of the chatbot, which may be used as a reference for showing differences between the personality of the user and others.

It should be appreciated that the result 800 is not limited to be in the form of graph as shown in FIG. 8, the result 800 may also be presented in any other evaluable and intuitive way, e.g., in tables, literal descriptions, etc. All the elements in the result 800, such as, the five dimensions, the pentagons, etc., are exemplary, and depending on specific application requirements, the result 800 may comprise any other equivalents, replacements, or revisions.

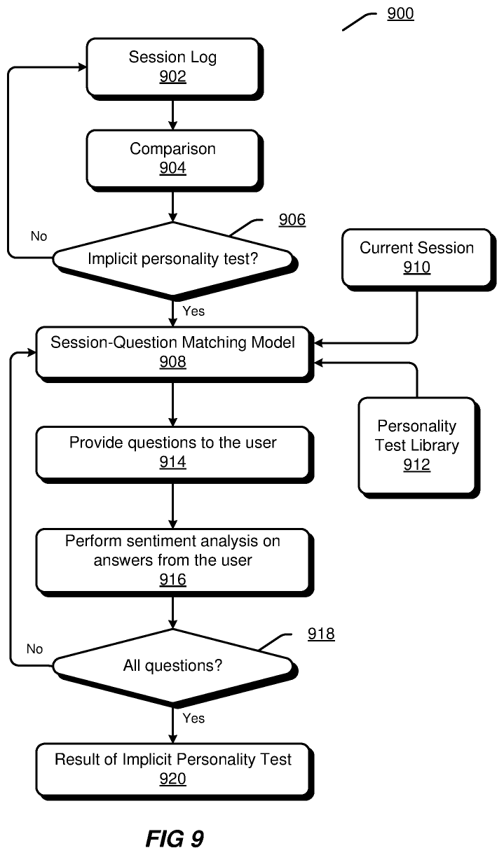

FIG. 9 illustrates an exemplary process 900 for performing an implicit personality test according to an embodiment. According to the process 900, it may be determined firstly that whether an implicit personality test should be performed on a user, then tests questions may be determined and provided to the user, and a result of the implicit personality rest may be obtained through sentiment analysis.

At 902, a session log of the user may be obtained. Herein, “session log” may refer to a record of sessions between the user and the chatbot.

In order to make a relatively easier judgment of a user's tendency in personality, it is preferred to perform implicit personality tests on those users that chat with the chatbot frequently and/or use rich emotional words in sessions. Thus, in some implementations, “log size” and/or “emotional word ratio” may be used for determining whether to perform an implicit personality test on a specific user. For example, at 904, a log size of the session log obtained at 902 may be determined, wherein the log size may indicate whether the user chat with the chatbot frequently. The log size may be further compared with a predefined size threshold. If the log size is above the size threshold, it may be determined at 906 to perform an implicit personality test on the user. As another example, at 904, an emotional word ratio of the session log obtained at 902 may be determined, wherein the emotional word ratio may be, such as, a ratio between the number of emotional words in the session log and the total number of words in the session log, and may indicate whether the user uses rich emotional words in sessions. The emotional word ratio may be further compared with a predefined ratio threshold. If the emotional word ratio is above the ratio threshold, it may be determined at 906 to perform an implicit personality test on the user. Moreover, the “log size” and the “emotional word ratio” may also be jointly used for determining whether to perform an implicit personality test at 906. It may be determined to perform an implicit personality test if at least one of the log size and the emotional word ratio is above a respective threshold, otherwise, the process 900 will return to 902.

When determining to perform an implicit personality test, a session-question matching model may be adopted at 908 for determining test questions in the implicit personality test based at least on the current session 910 and a personality test library 912.

The personality test library 912 may comprise a plurality of test questions and corresponding reference answers that are extracted from, such as, any existing manually-designed personality tests. In an implementation, in order to avoid the same usage of a similar test question to thousands of users, a test question in the personality test library 912 may be further transformed into a number of variants, through using Word2vec to rewrite one or more words in the test question into similar meaning synonyms. This is also intended to avoid fake answers from some anti-testing users.

Taking the chat flow in FIG. 7 as an example, as for the current session “User: Feeling so sad these days; Chatbot: What happened?; User: Work; Chatbot: A tight deadline?; User: Not about deadline, just judged too much by colleagues; Chatbot: Oh . . . that's easy to be tired; User: Yes, too tired”, the session-question matching model may determine the test question “So you frequently do not enjoy communicating with other people or you feel powerful when you are alone?”.

A gradient-boosting decision tree (GBDT) may be adopted in the session-question matching model to compute similarity scores between the current session 910 and test questions in the personality test library 912, wherein the test questions in the personality test library 912 may also be referred to as candidate test questions. Features in the GBDT may be based on at least one of: a language model for information retrieval, a translation-based language model, an edit distance between a candidate test question and the current session in a word or character level, a maximum subsequence ratio between a candidate test question and the current session, a cosine similarity score from a recurrent neural network (RNN) using gated recurrent units (GRUs), etc.

Through the session-question matching model, one or more test questions may be determined for the implicit personality test. At 914, the determined test questions may be sequentially provided to the user.

At 916, answers from the user may be analyzed. For example, sentiment analysis may be performed on the answers from the user, so as to detect the user's tendencies to the test questions.

In an implementation, the sentiment analysis may be used for identifying three emotion categories, e.g., “positive”, “negative” and “neutral”. It should be appreciated that the sentiment analysis here may also determine any other number of emotion categories, such as, eight emotion categories including “happy”, “angry”, “fearful”, “contemptuous”, “sad”, “surprise”, “disgusted” and “neutral”. The following discussion will take the sentiment analysis identifying three emotion categories as an example.

As for an exemplary test question “you feel powerful when you are alone?”, if the user's answer is “Yes, I prefer to work alone to focus”, the sentiment analysis may identify, from at least the expressions “Yes”, “prefer to work alone”, etc. in the answer, that an emotion category of the answer is “positive” as to the topic “feel powerful when alone” in the test question. Herein, “topic” may refer to a fact or assumption stated in the test question. In the same way, the sentiment analysis may be performed for determining an emotion category of an answer as to each of the test questions.

At 918, it may be determined whether all test questions in the implicit personality test have been sent to the user. If not, the process 900 may return to 908. If yes, a result of the implicit personality test may be generated at 920.

As discussed above, the result of the implicit personality test may comprise a set of personality scores, each personality score corresponding to one of the five personality factors. A personality score for a personality factor may be determined based at least on emotion categories of the user's answers to test questions relevant to this personality factor.

Still take the test question “you feel powerful when you are alone?” as an example, this test question directs to obtaining the user's tendency in the personality factor “extraversion”. As for the user's answer “Yes, I prefer to work alone to focus”, emotion category of the answer may be determined as “positive” through the sentiment analysis, and this emotion category may indicate that the user shows a negative tendency in “extraversion” in this answer. Through a statistical analysis on emotion categories of the user's answers to one or more “extraversion”-related test questions, a personality score may be obtained for the personality factor “extraversion”. In the same way, a personality score may be obtained for each of the five personality factors, and thus the result of the implicit personality test may be finally generated.

It should be appreciated that, although not shown in FIG. 9, there may be a test control strategy included in the process 900. For example, if there are a lot of test questions needed to be sent to the user so as to obtain a final result, the process 900 may record test questions that the user has answered, test questions remaining to be sent to the user, and time duration of the implicit personality test having be conducted. Thus, the whole implicit personality test may be conducted in several parts in two or more sessions, rather than conducted at a time.

Besides obtaining personality scores through performing sentiment analysis in implicit personality tests, the embodiments of the present disclosure further propose using a personality classification model to generate personality scores. The personality classification model may be established for generating personality scores based on input sentences. In some implementations, the personality classification model may be based on a RCNN.

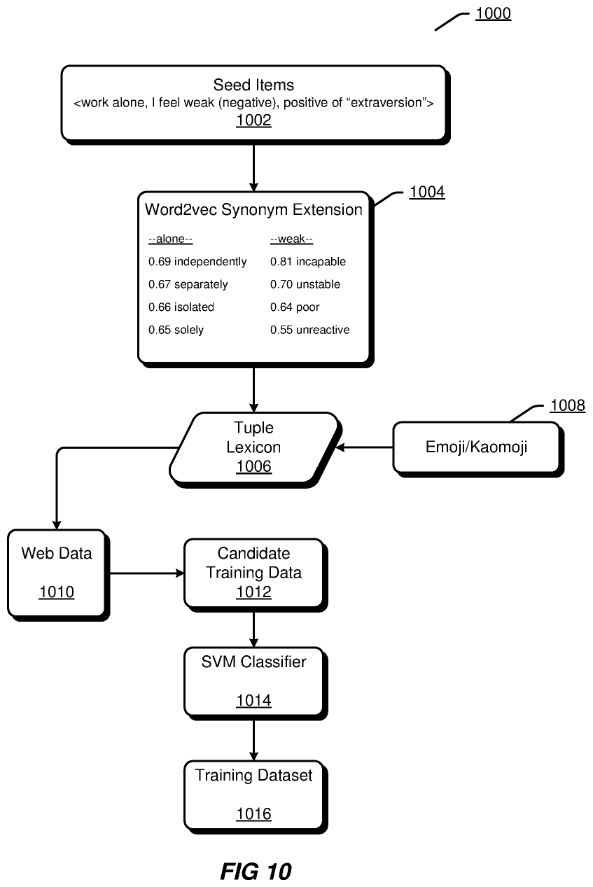

FIG. 10 illustrates an exemplary process 1000 for obtaining a training dataset for a personality classification model according to an embodiment. The process 1000 may be performed for generating a tuple lexicon by extending seed items, and further determining a training dataset based on the tuple lexicon.

At 1002, seed items may be obtained. Herein, a seed item may be in a form of <topic, answer+emotion category, personality>, where “topic” may be a fact or assumption stated in a test question, “answer+emotion category” may be an answer from the user to the test question together with an emotion category of the answer determined through sentiment analysis, and “personality” may be a negative or positive tendency for a personality factor. In an implementation, the seed items may be obtained through the process 900 of performing an implicit personality test in FIG. 9.

Take a test question “how do you feel when you work alone?” and an answer “I feel weak” as an example, “topic” may be “work alone” or similar expressions extracted from the test question, “answer+emotion category” may be “I feel weak (negative)” indicating that the answer “I feel weak” has a negative emotion to the test question, and “personality” may be “positive of extraversion” which is determined based on sentiment analysis on the answer and indicates a positive tendency of the user in terms of “extraversion”. Thus, a seed item may be formed as <work alone, I feel weak (negative), positive of “extraversion”>. It should be appreciated that the topic part in the seed item may comprise a portion or the whole of the test question, and the answer part may also comprise a portion or the whole of the answer. In this way, a set of seed items may be obtained through performing implicit personality tests.

At 1004, a Word2vec synonym extension may be performed on the seed items so as to extend the seed items. A Word2vec cosine similarity score between at least one word in the “topic” part or “answer” part of a seed item and a word from a corpus may be computed. In this way, for a target word in the “topic” part or “answer” part of the seed item, a number of words that are from the corpus and labeled by computed scores may be collected, and then one or more top-ranked words may be determined as extension words to the target word in the seed item.

As shown in FIG. 10, as for a seed item <work alone, I feel weak (negative), positive of “extraversion”>, extension words for “alone” in the topic part may be determined, based on the computed Word2vec cosine similarity scores, as “independently” being scored 0.69, “separately” being scored 0.67, “isolated” being scored 0.66, “solely” being scored 0.65, etc. Extension words for “weak” in the answer part may be determined as “incapable” being scored 0.81, “unstable” being scored 0.70, “poor” being scored 0.64, “unreactive” being scored 0.56, etc. With the extension words obtained above, a plurality of extended items may be formed through replacing original words by corresponding extension words. Some examples of extended items may be: <work independently, I feel weak (negative), positive of “extraversion”>, <work alone, I feel incapable (negative), positive of “extraversion”>, <work independently, I feel incapable (negative), positive of “extraversion”>, <work separately, I feel incapable (negative), positive of “extraversion”>, etc.

At 1006, a tuple lexicon may be formed by the seed items obtained at 1002 and the extended items obtained at 1004.

In an implementation, the “answer+emotion category” part of an item in the tuple lexicon may be further appended by corresponding emoticons, e.g., emoji or kaomoji, so as to enrich information of the “answer+emotion category” part. At 1008, emoji or kaomoji corresponding to each emotion category may be collected from the network. For example, for the emotion category “negative”, its corresponding emoticons may include, such as, “><”, “( [symbol] )”, etc. Accordingly, these emoticons may be appended to the “answer+emotion category” part of the items in the tuple lexicon based on emotion category.

The tuple lexicon formed at 1006 may be used for finding sentences, from web data 1010, that contain words, phrases, and/or emoticons in items in the tuple lexicon. For example, for each item in the tuple lexicon, one or more sentences may be collected, wherein each sentence may contain one or more words, phrases and/or emoticons in the item and may be labeled by a personality indicated in the item. The collected sentences together with corresponding personality labels are in a form of <sentence, personality>, and may be used as candidate training data 1012.

In some cases, the candidate training data 1012 may comprise some interference sentences that have obscure emotions or are difficult to identify emotions, and thus are difficult to determine definite personalities. An exemplary interference sentence may comprise a word “not” or its equivalents, which may switch from an original emotion to a contrary emotion. Another exemplary interference sentence may comprise both positive words and negative words in a mixture way, such as, “praise first and then criticize”. A support vector machine (SVM) classifier 1014 may be used for filtering out interference sentences from the candidate training data 1012. The SVM classifier 1014 may use trigram characters as features. A set of classifier training data may be obtained for training the SVM classifier 1014. Regarding emotions except “neutral”, instances may be manually labeled for each emotion category and then used as classifier training data, and regarding the emotion “neutral”, sentences that do not contain emotional words or emoji/kaomoji may be collected from the network as classifier training data.

Through the classifier training data, the SVM classifier 1014 may be trained for discriminating interference sentences from other sentences in the candidate training data 1012, and thus those candidate training data containing these interference sentences may be removed from the candidate training data 1012. The remaining candidate training data may form a training dataset 1016 for training the personality classification model.

It should be appreciated that the operation of Word2vec synonym extension at 1004, the operation of appending emoticons at 1008 and the operation by the SVM classifier 1014 are all optional in the process 1000. Thus, in other implementations, any one or more of these operations may be omitted from the process 1000.

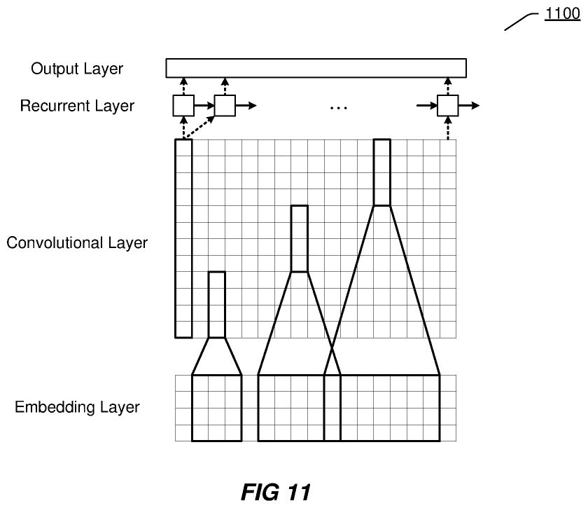

FIG. 11 illustrates an exemplary personality classification model 1100 according to an embodiment, which may be trained by the training dataset obtained in FIG. 10. As discussed above, the personality classification model 1100 may be based on a RCNN. In an implementation, the personality classification model 1100 may be based on a character-level RCNN. The character-level RCNN is capable of encoding both semantic and orthographic information from characters. The character-level RCNN may comprise an embedding layer, a convolutional layer, a recurrent layer and an output layer. It should be appreciated that, as for sentences in a character-style language, e.g., Japanese, Chinese, etc., characters in the sentences may be taken as basic units for embedding, while as for sentences in a word-style language, e.g., English, words in the sentences, instead of letters, may be taken as basic units for embedding. When the basic units in the embedding layer are “characters”, the convolutional layer is to find the best combinations of words each of which is combined by several characters. When the basic units in the embedding layer are “words”, the convolutional layer is to find the best combinations of phrases each of which is combined by several words. Although the following discussion aims at the case of “character”, similar technical means may also be applied for the case of “word”.

The embedding layer may convert a sentence into a dense vector space, e.g., generating a vector for each character in the sentence.

The convolutional layer may be based on a CNN, and may perform convolution operations on the vectors from the embedding layer, e.g., converting the vectors with various kernel sizes.

Let Q∈ [symbol] ^{d*|V|} be a character embedding matrix with d being the dimensionality of character embedding and V being a character vocabulary set. It is assumed that a word w=c₁, . . . , ₗ, which has l characters cⱼ. Then, a character-level representation of w is given by a matrix C^{w}∈ [symbol] ^{d*l}, where the j-th column of C^{w} corresponds to a character embedding for cⱼ which is further the j-th column of Q. A narrow convolution is applied between C^{w} and a filter or convolutional function H∈ [symbol] ^{d*f} with a width f. FIG. 11 shows three exemplary filters with widths f=3, 5 and 7. Then, a bias is added, and a nonlinearity transformation is applied to obtain a feature map f^{w} ∈ [symbol] ^{l-f+1}. The i-th element of f^{w} may be given as:

f^{w}[i]=tanh(<C^{w}[*,i: i+f−1], H>+b) Equation (1)

where C^{w}[*, i:1+f−1] is the i-to-(i+f−1)-th columns of C^{w}, and <A, B>=Tr(AB^{T}) is a Frobenius inner product.

In an implementation, the CNN at the convolutional layer may adopt, such as, a max pooling over time.

The recurrent layer may perform recurrent operations on outputs of the convolutional layer. It should be appreciated that, although FIG. 11 shows unidirectional recurrent operations in the recurrent layer, bidirectional recurrent operations may also be applied in the recurrent layer. The recurrent layer may also be referred to as a RNN layer, which may adopt long-short term memory (LSTM) units. The LSTM may address a learning problem of long distance dependencies and a gradient vanishing problem, through augmenting a traditional RNN with a memory cell vector cₜ∈ [symbol] ⁿ at each time step. One step of the LSTM takes xₜ, hₜ₋₁, cₜ₋₁ as inputs and produces hₜ, cₜ via the following intermediate calculations:

iₜ=σ(Wⁱxₜ+Uⁱhₜ₋₁+bⁱ) Equation (2)

fₜ=σ(W^{f}xₜ+U^{f}hₜ₋₁+b^{f}) Equation (3)

oₜ=σ(W^{o}xₜ+U^{o}hₜ₋₁+b^{o}) Equation (4)

gₜ=tanh(W^{g}xₜ+U^{g}hₜ₋₁+b^{g}) Equation (5)

cₜ=fₜ⊗cₜ₋₁+iₜ⊗gₜ Equation (6)

hₜ=oₜ⊗tanh(cₜ) Equation (7)

where σ(.) and tanh(.) are elementwise sigmoid and hyperbolic tangent functions, ⊗ is an elementwise multiplication operator, and iₜ, fₜ, o_{f} denote input gate, forget gate and output gate respectively. When t=1, h₀ and c₀ are initialized to be zero vectors. Parameters to be trained in the LSTM are the matrices W^{j}, U^{j}, and the bias vector b^{j}, where j∈{i, f, o, g}.

The output layer may use RNN states from the recurrent layer as feature bb bbvectors, and output personality scores. For example, the output layer may be a full connection layer that can convert a 256-dimension vector from the recurrent layer to an output of 5-dimension vector, wherein the 5-dimension vector corresponds to the five personality factors, and each dimension may have a personality score for a corresponding personality factor. In the case of outputting a 5-dimension vector, a personality score of a personality factor may be ranged in [−1, 1] where “−1” stands for maximum negative level of the personality factor, and “1” stands for maximum positive level of the personality factor. It should be appreciated that, in some implementations, instead of outputting a 5-dimension vector, the output layer may also output, such as, a 10-dimension vector. Each of the five personality factors may be indicated by two dimensions of the 10-dimension vector, one dimension having a personality score of the personality factor in a negative direction that is ranged in [0, 1], and another dimension having a personality score of the personality factor in a positive direction that is also ranged in [0, 1].

Through the personality classification model 1100, when inputting one or more sentences into the model, a set of personality scores may be obtained. Thus, as for a session log of a user, the personality classification model 1100 may generate a set of personality scores for the user based on messages and/or responses in the session log. Moreover, as for lines of a reference character, the personality classification model 1100 may generate a set of personality scores for the reference character based on sentences in the lines.

Implementations for generating personality scores through performing sentiment analysis in implicit personality tests or through the personality classification model have been discussed above in connection with FIG. 7 to FIG. 11, and these implementations may be further used for performing personality comparisons between a user and one or more reference characters and thus determining a reference character that corresponds to the user in personality.

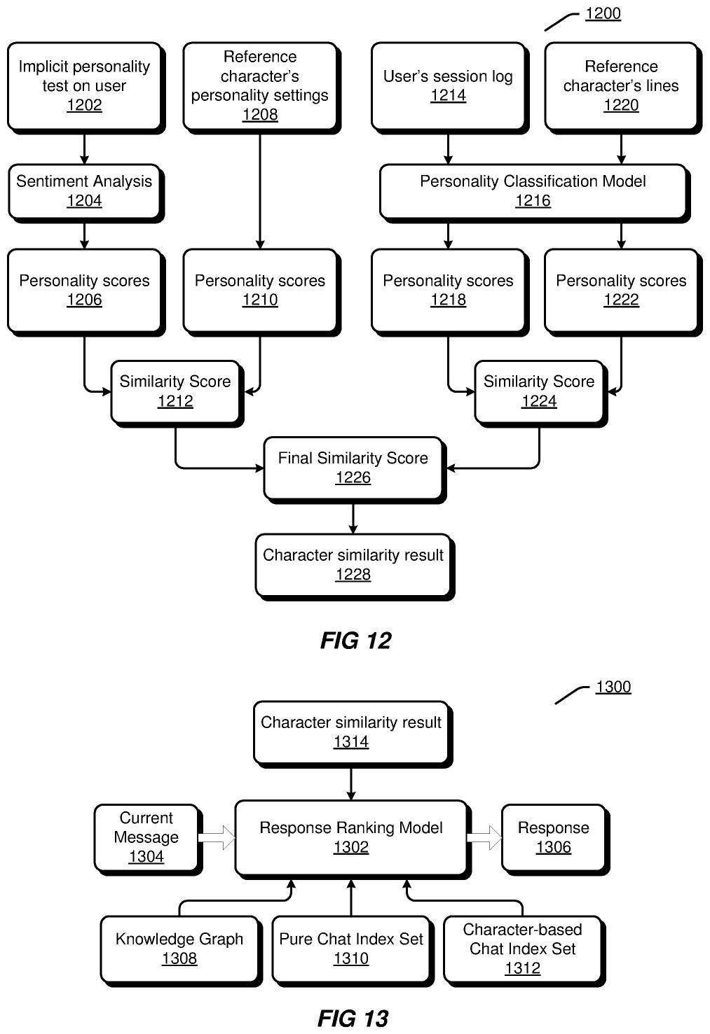

FIG. 12 illustrates an exemplary process 1200 for determining character similarity according to an embodiment. The process 1200 may perform personality comparisons between a user and one or more reference character based on personality scores, and determine a reference character that corresponds to the user in personality.

At 1202, at least one implicit personality test may be performed on the user. Sentiment analysis may be performed at 1204 on answers from the user to test questions in the implicit personality test. Through the sentiment analysis, a set of personality scores 1206 for the user may be obtained. The operations at 1202, 1204 and 1206 may follow the process 900 in FIG. 9.

At 1208, personality settings of a reference character may be obtained. Herein, “personality settings” may refer to personality characteristics set for the reference character when creating a cartoon, movie or play where the reference character exists. The personality settings may be obtained from introduction of the cartoon, movie or play, introduction of characters in the cartoon, movie or play, comments on the cartoon, movie or play from critics or audience, etc. on the network. The personality settings may comprise detailed descriptions of various personality factors of the reference character, and a set of personality scores 1210 for the reference character may be determined from the detailed descriptions through various approaches, e.g., through statistical analysis, etc.

A similarity score 1212 may be computed based on the set of personality scores 1206 and the set of personality scores 1210. For example, when denoting the set of personality scores 1206 as {x₁, x₂, x₃, x₄, x₅}, and denoting the set of personality scores 1210 as {y₁, y₂, y₃, y₄, y₅}, then the similarity score 1212 may be computed as Σᵢ₌₁⁵wᵢ|xᵢ−yᵢ|, where wᵢ is a weight for the i-th personality factor, and xᵢ and ᵢ, are a personality score of the user and a personality score of the reference character for the i-th personality factor respectively. The similarity score 1212 may indicate similarity between the user and the reference character in personality.

At 1214, a session log of the user may be obtained. The session log records messages and responses in sessions between the user and a chatbot. At 1216, a personality classification model may be used for generating a set of personality scores 1218 for the user based on the session log. The personality classification model may be established according to the discussion above in connection with FIG. 11.

At 1220, lines of the reference character that is involved at 1208 may be obtained. At 1216, the personality classification model may be used for generating a set of personality scores 1222 for the reference character based on sentences in the lines.

A similarity score 1224 may be computed based on the set of personality scores 1218 and the set of personality scores 1222 in the same way as the similarity 1212. The similarity score 1224 may also indicate similarity between the user and the reference character in personality.

Then, a final similarity score 1226 may be computed based on the similarity score 1212 and the similarity score 1224. For example, the final similarity score 1226 may be a sum of the similarity score 1212 and the similarity score 1224. This final similarity score 1226 may indicate similarity between the user and the reference character in personality as a whole.

In the same way as the operations from 1202 to 1226, final similarity scores between the user and other reference characters may also be computed. Then, a character similarity result 1228 may be obtained. In an implementation, the character similarity result 1228 may comprise an indication of a reference character that has a top-ranked final similarity score and is deemed as corresponding to the user in personality. Taking the scenario in FIG. 2 as an example, the chatbot may determine that the user is like Nobita in personality through the process 1200 in FIG. 12, and accordingly the chatbot that acts as Doraemon may respond to the user in a way similar as talking to Nobita. In another implementation, the character similarity result 1228 may further comprise the set of final similarity scores between the user and one or more reference characters computed at 1226.

It should be appreciated that, the computing of the final similarity score at 1226 is optional in the process 1200, and either of the similarity score 1212 and the similarity score 1224 may be used as a final similarity score directly and further used for determining the character similarity result 1228.

FIG. 13 illustrates an exemplary process 1300 for applying a response ranking model to determine a response according to an embodiment.

As shown in FIG. 13, a response ranking model 1302 may be used for taking a current message 1304 as input, and output a response 1306.

In an implementation, the response ranking model 1302 may determine the response 1306 based on a knowledge graph 1308 of a target character. As mentioned above, the knowledge graph 1308 may comprise various background information of the target character, and may also comprise QA pairs generated from the background information. In this case, if the current message 1304 from the user is about background information of the target character, e.g., “Doraemon, how old are you?”, and a QA pair <“How old are you?”, “I'm always 5 years old”> is included in the knowledge graph 1308 which is generated from age information of Doraemon, then through performing matching operations between the current message 1304 and QA pairs in the knowledge graph 1308, the response ranking model 1302 may provide the answer part “I'm always 5 years old” in the above QA pair as the response 1306 when determining that the current message 1304 is matched with the above QA pair. In a further implementation, if no matched response can be found from the knowledge graph 1308, the response ranking model 1302 may further try to find a response from a pure chat index set 1310 through any existing approaches.

In an implementation, the response ranking model 1302 may determine the response 1306 based on a character-based chat index set 1312. As discussed above, index items in the character-based chat index set 1312 may be in a form of <question, answer, character 1, character 2>, where the character 1 may be a reference character who says the “question”, and the character 2 mat be a target character who says the “answer”. In this case, the response ranking model 1302 may make a reference to a character similarity result 1314 that is obtained through the process 1200 in FIG. 12. For example, if the target character is Doraemon, and the character similarity result 1314 indicates that the user is like Nobita in personality, then when ranking responses, the response ranking model 1302 may give higher weights for those index items in the character-based chat index set 1312 in which “character 1” is Nobita and “character 2” is Doraemon.

In an implementation, the response ranking model 1302 may determine the response 1306 based on any combination of the knowledge graph 1308, the pure chat index set 1310, the character-based chat index set 1312, and the character similarity result 1314. In this case, the response ranking model 1302 may be a learning-to-rank (LTR) model, and may be based on a GBDT.

The GBDT may compute similarity scores between the current message 1304 and a set of questions or answers from the knowledge graph 1308, the pure chat index set 1310 or the character-based chat index set 1312. In the following discussion, questions and answers in the knowledge graph 1308, the pure chat index set 1310 and the character-based chat index set 1312 are referred to as candidate questions and candidate answers respectively.

In an implementation, a feature in the GBDT may be based on a similarity score between the user and a reference character, wherein the reference character is denoted by “character 1” in an index item <question, answer, character 1, character 2> in the character-based chat index set 1312. The similarity score between the user and the reference character may be contained in the character similarity result 1314. If a “character 1” in an index item corresponds to a higher similarity score, this index item may be given a higher weight than other index items.

In an implementation, a feature in the GBDT may be based on a language model for information retrieval. This feature may evaluate relevance between the current message q and a candidate question or answer Q through:

P(q|Q)=Π_{w∈q}[(1−λ)Pₘₗ(w|Q)+λPₘₗ(w|C)] Equation (8)

where Pₘₗ(w|Q) is the maximum likelihood of word w estimated from Q, and Pₘₗ(w|C) is a smoothing item that is computed as the maximum likelihood estimation in a large-scale corpus C. The smoothing item avoids zero probability, which stems from those words appearing in q but not in Q. λ is a parameter that acts as a trade-off between the likelihood and the smoothing item, where λ∈[0, 1].

In an implementation, a feature in the GBDT may be based on a translation-based language model. This feature may learn word-to-word and/or phrase-to-phrase translation probability from, such as, candidate questions, and may incorporate the learned information into the maximum likelihood. Given a current message q and a candidate question Q, the translation-based language model may be defined as:

P_{trb}(q|Q)=Π_{w∈q}[(1−λ)Pₘₓ(w|Q)+λPₘₗ(w|C)] Equation (9)

where Pₘₓ(w|Q)=αPₘₗ(w|Q)+βPₜᵣ(w|Q) Equation (10)

Pₜᵣ(w|Q)=Σ_{ν∈Q}Pₜₚ(w|ν)Pₘₗ(ν|Q) Equation (11)

Here, λ, α and β are parameters satisfying λ∈[0, 1] and α+β=1. Pₜₚ(w|ν) is a translation probability from word v in Q to word w in q. Pₜᵣ(.), Pₘₓ(.) and P_{trb}(.) are similarity functions constructed step-by-step by using Pₜₚ(.) and Pₘₗ(.).

In an implementation, a feature in the GBDT may be an edit distance between a current message and a candidate question in a word or character level.

In an implementation, a feature in the GBDT may be a maximum subsequence ratio between a current message and a candidate question.

In an implementation, a feature in the GBDT may be a cosine similarity score from a RNN using GRUs. The cosine similarity score may be an evaluation for similarity between a current message and a candidate answer. The current message and the candidate answer may be input into a respective RNN-GRU layer so as to obtain corresponding dense vectors respectively. The dense vectors may be further used for determining a similarity score between the current message and the candidate answer.

Through the response ranking model as discussed above, a set of similarity scores between the current message 1304 and a set of candidate questions or candidate answers may be obtained respectively, and accordingly, QA pairs in the knowledge graph 1308, the pure chat index set 1310, the character-based chat index set 1312 may be ranked based on these similarity scores. An answer in a top-ranked QA pair may be selected as the response 1306. In an implementation, the response 1306 may be provided to the user as a reply to the current message 1304.

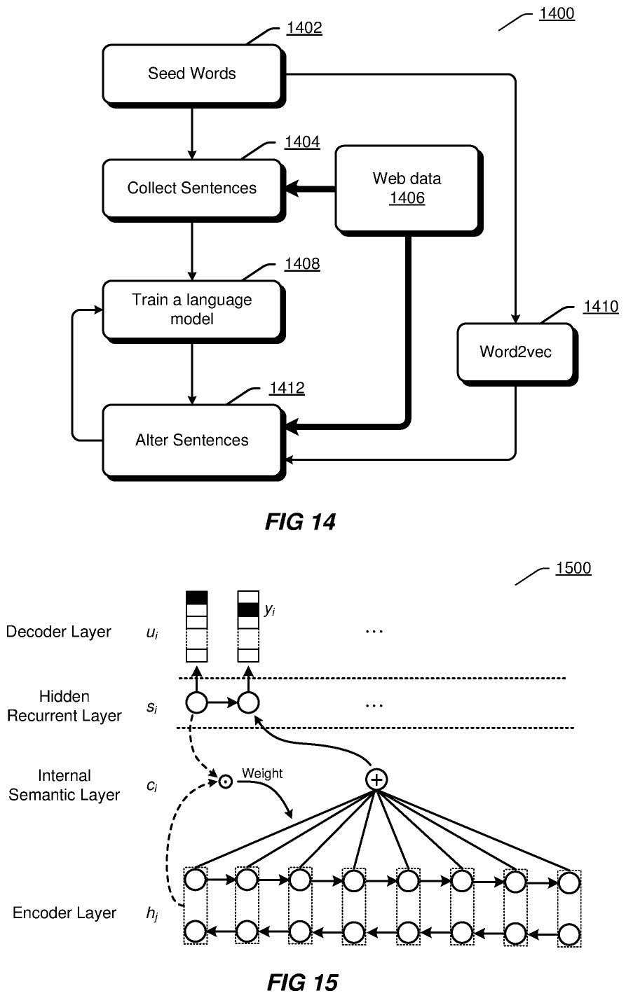

FIG. 14 illustrates an exemplary process 1400 for establishing a language model for a target character according to an embodiment. The language model may be established for modeling a language style of the target character.

At 1402, one or more seed words may be determined from lines of the target character in a cartoon, movie or play where the target character exists. Herein, “seed words” may refer to representative or important words that are most frequently used by the target character. The seed words may be determined from the lines through various term-weight algorithms, e.g., term frequency-inverse document frequency (TF-IDF), etc.

At 1404, sentences may be collected from web data 1406 through matching with the seed words. For example, the collected sentences may be from various content providing websites, social networks, etc. The collected sentences may comprise at least one of the seed words. The collected sentences may be used as training data and form a training set.

At 1408, a language model for the target character may be trained based on the collected sentences in the training set. In an implementation, the language model may be a recurrent neural network language model (RNNLM). The RNNLM may be based on a general structure of RNN. Through the training operation at 1408, the language model may be established for characterizing the language style of the target character.

In an implementation, the process 1400 may further comprise an updating procedure for the language model. At 1410, a Word2vec process may be used for determining extension words for the seed words in a vector space, wherein the extension words may refer to those words that are semantically relevant to the seed words. Then, sentences may be crawled from the web data 1406 based on the extension words. At 1412, the crawled sentences may be altered through replacing one or more words in the crawled sentences by semantically-relevant seed words. For example, an extension word “beautiful” may be determined through Word2vec for a seed word “pretty”, and meanwhile an extension word “wise” may be determined through Word2vec for a seed word “clever”. If a sentence “She is a beautiful and wise girl” is crawled based on the extension word “beautiful”, then since the word “wise” in the crawled sentence is semantically relevant to the seed word “clever”, this crawled sentence may be altered as “She is a beautiful and clever girl”.

The crawled sentence “She is a beautiful and wise girl” and the altered sentence “She is a beautiful and clever girl” may be used as new training data for extending the training set. Thus, the process 1400 may further update the language model based on these two sentences. For example, the language model may be retrained based on these two sentences. It should be appreciated that, in another implementation, before using these two sentences as new training data, it may be determined whether these two sentences meet the language model, e.g., whether these two sentences may be scored by the language model as above a threshold. Only the sentence being scored above the threshold may be used as new training data for updating the language model.

According to the embodiments of the present disclosure, a language style rewriting model may be established for rewriting a sentence into another sentence that is in a language style of a target character. FIG. 15 illustrates an exemplary language style rewriting model 1500 according to an embodiment. The language style rewriting model 1500 may perform rewriting operation with a language model established according to the process 1400 in FIG. 14 and/or a personality classification model 1100 as shown in FIG. 11 cooperatively.

As shown in FIG. 15, the language style rewriting model 1500 may have an attention-based encoder-decoder style structure, and may comprise an encoder layer, an internal semantic layer, a hidden recurrent layer, and a decoder layer.

At the encoder layer, a language model for a target character may be adopted for obtaining word vectors for an input sequence, e.g., a sentence. The language model may be a RNNLM that is established according to the process 1400 in FIG. 14. Then, bidirectional recurrent operations may be applied on the word vectors so as to obtain source vectors. There are two directions involved in the bidirectional recurrent operations, e.g., left-to-right and right-to-left. The bidirectional recurrent operations may be based on, such as, a GRU style recurrent neural networks. The encoder layer may also be referred to as “embedding” layer. The source vectors may be denoted by temporal annotation hⱼ, where j=1, 2, . . . , Tₓ, and Tₓ is the length of the input sequence, e.g., the number of words in the input sequence.

Internal mechanism of a GRU process may be defined by the following equations:

zₜ=σ_{g}(W^{(z)}xₜ+U^{(z)}hₜ₋₁+b^{(z)}) Equation (12)

rₜ=σ_{g}(W^{(r)}xₜ+U^{(r)}hₜ₋₁+b^{(r)}) Equation (13)

\tilde{h}ₜ=σₕ(W^{(h)}xₜ+U^{(h)}rₜ^{o}hₜ₋₁)+b^{(h)}) Equation (4)

hₜ=zₜ^{o}hₜ₋₁+(1−zₜ)^{o}\tilde{h}ₜ Equation (5)

where xₜ is an input vector, hₜ is an output vector, zₜ is an update gate vector, rₜ is a reset gate vector, σ_{g} is from a sigmoid function, σₕ is from a hyperbolic function, ∘ is an element-wise product, and h₀=0. Moreover W^{(z)}, W^{(r)}, W^{(h)}, U^{(z)}, U^{(r)}, U^{(h)}, are parameter matrices, and b^{(z)}, b^{(z)}, b^{(z)}, are parameter vectors. Here, W^{(z)}, W^{(r)}, W^{(h)}, ∈Rⁿ^{_{H}}^{×n}^{_{I}}, and U^{(z)}, U^{(r)}, U^{(h)}, U(^{h})∈Rⁿ^{_{H}}^{×n}^{_{H}}, n_{H} denoting a dimension of a hidden layer, and n_{I} denoting a dimension of the input vector. For example, in Equation (12), W^{(z)} is a matrix that projects the input vector xₜ into a vector space, U^{(z)} is a matrix that projects the recurrent hidden layer hₜ₋₁ into a vector space, and b^{(z)} is a bias vector that determines a relative position of the target vector zₜ. Similarly, in Equations (13) and (14), W^{(r)}, U^{(r)}, b^{(r)}, and W^{(h)}, U^{(h)}, b^{(h)} function in the same way as W^{(z)}, U^{(z)} ) and b^{(z)}.

At the internal semantic layer, an attention mechanism may be implemented. A context vector cᵢ may be computed based on a set of temporal annotations hⱼ which may be taken as a temporal dense representation of the current input sequence. The context vector cᵢ may be computed as a weighted sum of the temporal annotations hⱼ as follows:

cᵢ=Σⱼ₌₁^{T}^{ₓ}aᵢⱼhⱼ Equation (16)

The weight aᵢⱼ for each hⱼ may also be referred to as “attention” weight, and may be computed by a softmax function:

$${α}_{ij} = \frac{exp ( {e}_{ij} )}{{\sum }_{k = 1}^{{T}_{x}} exp ( {e}_{ik} )} \qquad Equation ( 17 )$$

where eᵢⱼ=a(sᵢ₋₁, h₁) is an alignment model which scores how well inputs around a position j and an output at position i match with each other. The alignment score is between a pervious hidden state sᵢ₋₁ and the j-th temporal annotation hⱼ of the input sequence. The probability aᵢⱼ reflects importance of hⱼ with respect to the previous hidden state sᵢ₋₁ in deciding the next hidden state sᵢ and simultaneously generating the next word yᵢ. The internal semantic layer implements an attention mechanism through applying the weight aᵢⱼ.

At the hidden recurrent layer, hidden states sᵢ for an output sequence are determined through unidirectional, e.g., left-to-right, recurrent operations. The unidirectional recurrent operations may be performed by, such as, unidirectional recurrent GRU units.

At the decoder layer, word prediction for the next word y, may be determined as follows:

p(yᵢ|y₁, . . . , yᵢ₋₁, x)=g(yᵢ₋₁, sᵢ, cᵢ) Equation (18)

where sᵢ is from the hidden recurrent layer, cᵢ is from the internal semantic layer. Here, g(.) function is a nonlinear, potentially multi-layered function that outputs probabilities of the next candidate words in the output sequence. The decoder layer may also be referred to as an “output” layer.

It should be appreciated that the decoder layer may use the language model for the target character for ranking the next candidate word in the output sequence. This may further ensure that the output sequence is in the language style of the target character.

In an implementation, a loss function that is based on a personality classification model 1100 as shown in FIG. 11 may be optionally used for guiding the training of the language style rewriting model 1500, such that the output sentence may be generated in a target language style. The loss function may be expressed as:

Loss=|Score(output sequence)−Score(reference sentence)| Equation (19)

where Score(x)=Personality classification model (x), which denotes a set of personality scores obtained by the personality classification model based on input x, the output sequence is obtained through the language style rewriting model for an input sequence, and the reference sentence may be a sentence manually-labeled in the language style of the target character with respect to the input sequence or a sentence said by the target character and relevant to the input sequence. The loss function intends to identify a difference between the output sequence obtained through the language style rewriting model and the reference sentence in the language style of the target character, and may help to train the language style rewriting model to output sentences that approximate the language style of the target character.

In a further implementation, the above loss function may further consider a result of personality comparison, e.g., the character similarity result 1228 in FIG. 12. For example, if the target character is Doraemon, and a reference character corresponding to the user is determined through personality comparison as Nobita, then it is desired that the chatbot may respond to the user in a manner similar as Doraemon talks to Nobita. Thus, the loss function may be used for guiding the language style rewriting model 1500 to output sentences not only in the language style of Doraemon, but also in a manner that Doraemon talks to Nobita. In this case, the reference sentence in the loss function may be determined or selected as a sentence that was or can be said by Doraemon to Nobita. Accordingly, the loss function may help training the language style rewriting model to output sentences that approximate the language style of the target character, and meanwhile stimulate the manner that the target character talks to the reference character.

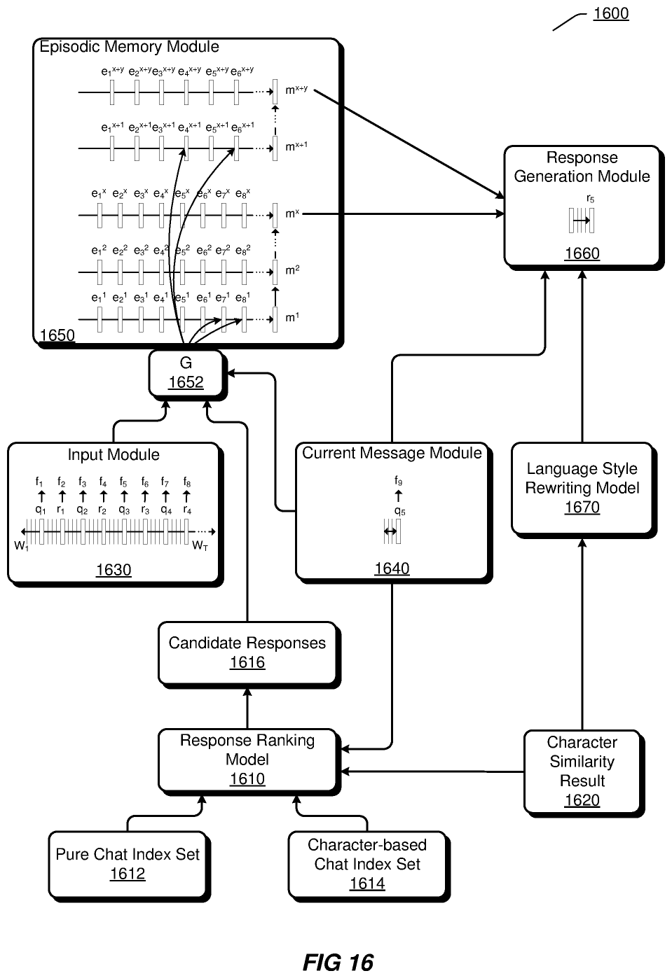

FIG. 16 illustrates an exemplary framework 1600 for generating responses through DMN according to an embodiment. The framework 1600 may be configured for generating or reasoning out a response in a word-by-word approach for a current message.

The framework 1600 may comprise a response ranking model 1610. The response ranking model 1610 may provide one or more candidate responses 1616 for the current message. The response ranking model 1610 may rank QA pairs in a pure chat index set 1612 and/or a character-based chat index set 1614, and select answers in one or more top-ranked QA pairs as the candidate responses. During the ranking, the response ranking model 1610 may make a reference to a character similarity result 1620, such that the ranking may be based on personality comparison. The character similarity result 1620 may be obtained through the process 1200 in FIG. 12, and may comprise an indication of a reference character corresponding to the user and/or similarity scores between the user and one or more reference characters. The response ranking model 1610 may operate in a similar way with the response ranking model 1302 in FIG. 13, except that the response ranking model 1610 may output more than one response as the candidate responses 1616. Through applying the response ranking model 1610 in the framework 1600 for retrieving relevant information from open domain data resources, e.g., existing QA pairs, and providing a list of candidate responses to the following reasoning, diversity of responses output by the framework 1600 may be improved.

The framework 1600 may comprise an input module 1630. At the input module 1630, a current session between the user and the chatbot, as context information, may be processed. For example, a sequence of sentences q₁ to q₄ and r₁ to r₄ in the current session may be provided to the input module 1630, wherein q₁ to q₄ are messages from the user in the current session, and r₁ to r₄ are responses by the chatbot to the messages q₁ to q₄ in the current session. Each sentence is ended with “</s>” to denote the ending of one sentence. All the eight sentences may be concatenated together to form an input sequence having T words, from W₁ to W_{T}. A bidirectional GRU encoding may be applied on the input sequence according to Equations (12)-(15). For the left-to-right direction or the right-to-left direction, at each time step t, hidden state may be updated as hₜ=GRU(L[wₜ], hₜ₋₋₁), where L is an embedding matrix, and wₜ is a word index of the t-th word in the input sequence. Thus, a resulting representation vector for a sentence is a combination of two vectors and each vector is from one direction.

In addition to encoding the input sequence, a positional encoding with bidirectional GRU may also be applied so as to represent “facts” of the sentences. Facts may be computed as fₜ=GRUₗ₂(L [Sₜ], fₜ₋₁)+GRUᵣ₂ₗ(L[Sₜ], fₜ₋₁), where l2r denotes left-to-right, r2l denotes right-to-left, Sₜ is an embedding expression of a current sentence, and fₜ₋₁, fₜ are fact vectors of a former sentence and the current sentence respectively. As shown in FIG. 16, fact vectors f₁ to f₈ are obtained for the eight sentences in the current session.

The framework 1600 may comprise a current message module 1640. At the current message module 1640, a current message q₅ that is currently input by the user may be processed. The encoding for the current message q₅ is a simplified version of the input module 1630, where there is only one sentence to be processed in the current message module 1640. The processing by the current message module 1640 is similar with the input module 1630. Assuming that there are T_{Q} words in the current message, hidden states of the encoding at the time step t may be computed as qₜ=[GRUₗ₂ᵣ(L[Wₜ^{Q}], qₜ₋₁), GRUᵣ₂ₗ(L[Wₜ^{Q}], qₜ₋₁)], where L is an embedding matrix, and Wₜ^{Q} is a word index of the t-th word in the current message. In a similar way as the input module 1630, a fact vector f₉ may be obtained for the current message q₅ in the current message module 1640.

The framework 1600 may comprise an episodic memory module 1650. The episodic memory module 1650 may be used for reasoning out memory vectors. In an implementation, the episodic memory module 1650 may comprise an attention mechanism module 1652. Alternatively, the attention mechanism module 1652 may also be separated from the episodic memory module 1650. The attention mechanism module 1652 may be based on a gating function.

In a conventional computing process through an episodic memory module and an attention mechanism module, these two modules may cooperate to update episodic memory in an iteration way. For each pass i, the gating function of the attention mechanism module may take a fact fⁱ, a previous memory vector m^{i<1}, and a current message q as inputs, to compute an attention gate gₜⁱ=G[fⁱ, mⁱ⁻¹, q]. To compute the episode eⁱ for pass i, a GRU over a sequence of inputs, e.g., a list of facts fⁱ, weighted by the gates gⁱ may be applied. Then the memory vector may be computed as mⁱ=GRU (eⁱ, mⁱ⁻¹). Initially, m° is equal to a vector expression of the current message q. The memory vector that is finally output by the episodic memory module may be the final state mx of the GRU. The following Equation (20) is for updating hidden states of the GRU at a time step t, and the following Equation (21) is for computing the episode.

hₜⁱ=gₜⁱGRU(fₜ, hₜ₋₁ⁱ)+(1−gₜⁱ)hₜ₋₁ⁱ Equation (20)

eⁱ=h_{T}_{_{C}}ⁱ Equation (21)

where T_{C} is the number of input sentences.

While according to the embodiments of the present disclosure, in order to generate an optimal response, besides reasoning from facts of the current session, external facts may also be considered in the case that the facts of the current session are not sufficient for answering the current message. Accordingly, facts of the candidate responses 1616 may be provided to the episodic memory module 1650 for further multiple-round transition reasoning.

The episodic memory module 1650 may make use of fact vectors of the current session and fact vectors of the candidate fact responses. Here, the fact vectors of the candidate fact responses may be computed in a similar way as the fact vectors of the current session. As shown in FIG. 16, memory vectors m^{l} to m^{x} correspond to a reasoning process starting from exemplary fact vectors f₁ to f₈ of the current session, and memory vectors m^{x+1} to m^{x+y} correspond to a reasoning process starting from fact vectors of exemplary 6 candidate responses.

Regarding the attention mechanism module 1652, for each pass i, inputs to the attention mechanism module 1652 may comprise at least one of: fact vector fᵢ from the current session, a previous memory vector mⁱ⁻¹ reasoned out from fact vectors of the current session, a fact vector f₉ of the current message, and a previous fact memory vector m^{x+i-1} reasoned out from fact vectors of the candidate responses. Thus, an attention gate may be computed as gₜⁱ=G[fᵢ, mⁱ⁻¹, [symbol] m^{x+i-1}]. The scoring function G may produce a scalar score for the feature set {fᵢ, mⁱ⁻¹, [symbol] m^{x i-1}}. For example, cosine similarity scores among these vectors may be used for the feature set. Computing results from the attention mechanism module 1652 may be applied in the reasoning process of the episodic memory module 1650.

Outputs from the episodic memory module 1650 may comprise at least the memory vectors m^{x} and m^{x+y}, where m^{x} reasoned out from the fact vectors of the current session, and m^{x+y} is reasoned out from the fact vectors of the candidate responses.

The framework 1600 may comprise a response generation module 1660. The response generation module 1660 may decide a response word-by-word, wherein the response will be provided to the user as a reply to the current message from the user. In an implementation, the response generation module 1660 may cooperate with a language style rewriting model 1670 to generate each word in the response. The language style rewriting model 1670 may be the same as the language style rewriting model 1500 in FIG. 15. As shown in FIG. 16, the character similarity result 1620 may be provided to the language style rewriting model 1670, such that outputs of the language style rewriting model 1670 may not only approximate the language style of the target character, but also stimulate the manner that the target character talks to the reference character.

The response generation module 1660 may adopt a GRU decoder, and an initial state of the GRU decoder may be initialized to be the last memory α₀=[m^{x}, m^{x+y}]. At a time step t, the GRU decoder may take the current message q₅, a last hidden state αₜ₋₁, a previous output yₜ₋₁, as well as the language style rewriting model 1670 as inputs, and then compute a current output as:

yₜ=softmax(W^{(a)}aₜ) Equation (22)

aₜ=GRU([yₜ₋₁, q₅], aₜ₋₁)+style_rewrite_model(yₜ|yₜ₋₁, yₜ₋ₙ₊₁) Equation (23)

where W^{(a)} is a weight matrix, and style_rewrite_model(yₜ|yₜ₋₁, yₜ₋ₙ₊₁) denotes a prediction of yₜ through the language style rewriting model 1670 by given yₜ₋₁ to yₜ₋ₙ₊₁.

The last generated word may be concatenated to the current vector as input at each time step. The generated output by the response generation module 1660 may be trained with a cross-entropy error classification of a correct sequence attached with a “</s>” tag at the end of the sequence.

Finally, a response r₅ to the current message may be obtained from the response generation module 1660. This response may be in the language style of the target character.

It should be appreciated that, in the framework 1600, the input module 1630, the current message module 1640, the episodic memory module 1650, the attention mechanism module 1652 and the response generation module 1660 are all directly involved in the memory-based reasoning of the response, and thus may also be collectively referred to as a DMN module.

It should be appreciated that all the modules, equations, parameters and processes discussed above in connection with FIG. 16 are exemplary, and the embodiments of the present disclosure are not limited to any details in the discussion.

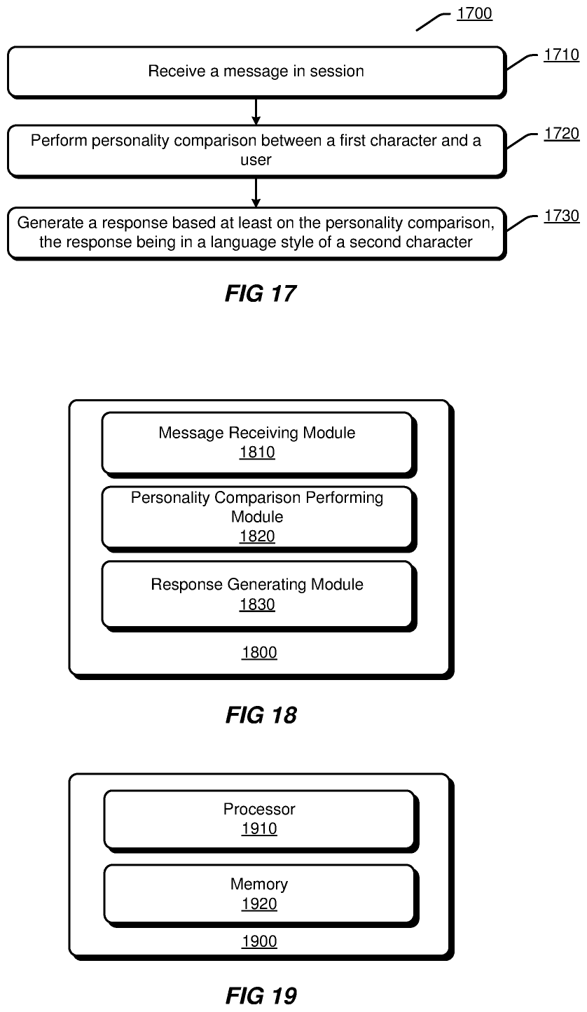

FIG. 17 illustrates a flowchart of an exemplary method 1700 for generating responses in automated chatting according to an embodiment.

At 1710, a message may be received in a session.

At 1720, personality comparison between a first character and a user may be performed.

At 1730, a response may be generated based at least on the personality comparison, the response being in a language style of a second character.

In an implementation, the performing the personality comparison may comprise: determining a first set of personality scores of the user through performing an implicit personality test; determining a second set of personality scores of the first character based on personality settings of the first character; and computing a first similarity score based on the first set of personality scores and the second set of personality scores.

In an implementation, the determining the first set of personality scores may comprise: receiving one or more answers during performing the implicit personality test; performing sentiment analysis on the one or more answers to determine one or more emotion categories corresponding to the one or more answers; and determining the first set of personality scores based at least on the one or more emotion categories.

In an implementation, the method 1700 may further comprise: presenting a result of the implicit personality test based on the first set of personality scores.

In an implementation, the performing the personality comparison may comprise: determining a third set of personality scores of the user based on the user's session log through a personality classification model; determining a fourth set of personality scores of the first character based on the first character's session log through the personality classification model; and computing a second similarity score based on the third set of personality scores and the fourth set of personality scores.

In an implementation, the personality classification model is based on a RCNN, and a training dataset for the personality classification model is obtained at least through the implicit personality test.

In an implementation, the method 1700 may further comprise: determining that the user is corresponding to the first character based on at least one of the first similarity score and the second similarity score.

In an implementation, the generating the response may comprise: generating the response through DMN.

In an implementation, the generating the response may comprise: determining one or more candidate responses based at least on the personality comparison; and reasoning out the response based at least on the one or more candidate responses.

In an implementation, the generating the response may comprise: reasoning out the response through applying a language style rewriting model, the language style rewriting model being established for converting an input sequence to an output sentence in the language style of the second character based at least on the personality comparison.

In an implementation, the method 1700 may further comprise: establishing a language model for the second character; obtaining vector representations of the input sequence through the language model, at an encoder layer of the language style rewriting model; and ranking next candidate word in the output sentence through the language model, at a decoder layer of the language style rewriting model.

In an implementation, the language style rewriting model may be trained at least through a loss function that is based on a personality classification model.

In an implementation, the method 1700 may further comprise: presenting a plurality of candidate characters; and receiving a selection of the second character among the plurality of candidate characters.

It should be appreciated that the method 1700 may further comprise any steps/processes for generating responses in automated chatting according to the embodiments of the present disclosure as mentioned above.

FIG. 18 illustrates an exemplary apparatus 1800 for generating responses in automated chatting according to an embodiment.

The apparatus 1800 may comprise: a message receiving module 1810, for receiving a message in a session; a personality comparison performing module 1820, for performing personality comparison between a first character and a user; and a response generating module 1830, for generating a response based at least on the personality comparison, the response being in a language style of a second character.

In an implementation, the personality comparison performing module 1820 may be further for: determining a first set of personality scores of the user through performing an implicit personality test; determining a second set of personality scores of the first character based on personality settings of the first character; and computing a first similarity score based on the first set of personality scores and the second set of personality scores.

In an implementation, the personality comparison performing module 1820 may be further for: determining a third set of personality scores of the user based on the user's session log through a personality classification model; determining a fourth set of personality scores of the first character based on the first character's session log through the personality classification model; and computing a second similarity score based on the third set of personality scores and the fourth set of personality scores.

In an implementation, the response generating module 1830 may be further for: generating the response through DMN.

In an implementation, the response generating module 1830 may be further for: determining one or more candidate responses based at least on the personality comparison; and reasoning out the response based at least on the one or more candidate responses.

In an implementation, the response generating module 1830 may be further for: reasoning out the response through applying a language style rewriting model, the language style rewriting model being established for converting an input sequence to an output sentence in the language style of the second character based at least on the personality comparison.

Moreover, the apparatus 1800 may also comprise any other modules configured for generating responses in automated chatting according to the embodiments of the present disclosure as mentioned above.

FIG. 19 illustrates an exemplary apparatus 1900 for generating responses in automated chatting according to an embodiment.

The apparatus 1900 may comprise at least one processor 1910. The apparatus 1900 may further comprise a memory 1920 that is connected with the processor 1910. The memory 1920 may store computer-executable instructions that, when executed, cause the processor 1910 to perform any operations of the methods for generating responses in automated chatting according to the embodiments of the present disclosure as mentioned above. Alternatively, the memory 1920 may also be omitted from the apparatus 1900.

The embodiments of the present disclosure may be embodied in a non-transitory computer-readable medium. The non-transitory computer-readable medium may comprise instructions that, when executed, cause one or more processors to perform any operations of the methods for generating responses in automated chatting according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors (e.g., cache or register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the claims.

What is claimed is:

1. A method for generating responses in automated chatting, comprising:
receiving a message in a session;
performing personality comparison between a first character and a user; and
generating a response based at least on the personality comparison, the response being in a language style of a second character.

2. The method of claim 1, wherein the performing the personality comparison comprises:
determining a first set of personality scores of the user through performing an implicit personality test;
determining a second set of personality scores of the first character based on personality settings of the first character; and
computing a first similarity score based on the first set of personality scores and the second set of personality scores.

3. The method of claim 2, wherein the determining the first set of personality scores comprises:
receiving one or more answers during performing the implicit personality test;
performing sentiment analysis on the one or more answers to determine one or more emotion categories corresponding to the one or more answers; and
determining the first set of personality scores based at least on the one or more emotion categories.

4. The method of claim 2, further comprising:
presenting a result of the implicit personality test based on the first set of personality scores.

5. The method of claim 2, wherein the performing the personality comparison comprises:
determining a third set of personality scores of the user based on the user's session log through a personality classification model;
determining a fourth set of personality scores of the first character based on the first character's session log through the personality classification model; and
computing a second similarity score based on the third set of personality scores and the fourth set of personality scores.

6. The method of claim 5, wherein the personality classification model is based on a recurrent convolutional neural network (RCNN), and a training dataset for the personality classification model is obtained at least through the implicit personality test.

7. The method of claim 5, further comprising:
determining that the user is corresponding to the first character based on at least one of the first similarity score and the second similarity score.

8. The method of claim 1, wherein the generating the response comprises:
generating the response through dynamic memory network (DMN).

9. The method of claim 8, wherein the generating the response comprises:
determining one or more candidate responses based at least on the personality comparison; and
reasoning out the response based at least on the one or more candidate responses.

10. The method of claim 8, wherein the generating the response comprises:
reasoning out the response through applying a language style rewriting model, the language style rewriting model being established for converting an input sequence to an output sentence in the language style of the second character based at least on the personality comparison.

11. The method of claim 10, further comprising:
establishing a language model for the second character;
obtaining vector representations of the input sequence through the language model, at an encoder layer of the language style rewriting model; and
ranking next candidate word in the output sentence through the language model, at a decoder layer of the language style rewriting model.

12. The method of claim 11, wherein the language style rewriting model is trained at least through a loss function that is based on a personality classification model.

13. The method of claim 1, further comprising:
presenting a plurality of candidate characters; and
receiving a selection of the second character among the plurality of candidate characters.

14. An apparatus for generating responses in automated chatting, comprising:
a message receiving module, for receiving a message in a session;
a personality comparison performing module, for performing personality comparison between a first character and a user; and
a response generating module, for generating a response based at least on the personality comparison, the response being in a language style of a second character.

15. The apparatus of claim 14, wherein the personality comparison performing module is further for:
determining a first set of personality scores of the user through performing an implicit personality test;
determining a second set of personality scores of the first character based on personality settings of the first character; and
computing a first similarity score based on the first set of personality scores and the second set of personality scores.

16. The apparatus of claim 15, wherein the personality comparison performing module is further for:
determining a third set of personality scores of the user based on the user's session log through a personality classification model;
determining a fourth set of personality scores of the first character based on the first character's session log through the personality classification model; and
computing a second similarity score based on the third set of personality scores and the fourth set of personality scores.

17. The apparatus of claim 14, wherein the response generating module is further for:
generating the response through dynamic memory network (DMN).

18. The apparatus of claim 17, wherein the response generating module is further for:
determining one or more candidate responses based at least on the personality comparison; and
reasoning out the response based at least on the one or more candidate responses.

19. The apparatus of claim 17, wherein the response generating module is further for:
reasoning out the response through applying a language style rewriting model, the language style rewriting model being established for converting an input sequence to an output sentence in the language style of the second character based at least on the personality comparison.

20. An apparatus for generating responses in automated chatting, comprising:
one or more processors; and
a memory storing computer-executable instructions that, when executed, cause the one or more processors to:
receive a message in a session;
perform personality comparison between a first character and a user; and
generate a response based at least on the personality comparison, the response being in a language style of a second character.
